(19) United States
(12) Patent Application Publication
(10) Pub. No.: US 2012/0224626 A1
(43) Pub. Date: Sep. 6, 2012

(54) ENCODER, VIDEO TRANSMISSION APPARATUS AND ENCODING METHOD

(75) Inventor: Kyungwoon Jang, Kanagawa (JP)

(73) Assignee: KABUSHIKI KAISHA TOSHIBA, Tokyo (JP)

(21) Appl. No.: 13/407,098

(22) Filed: Feb. 28, 2012

(30) Foreign Application Priority Data
Mar. 1, 2011 (JP) 2011-044370

(51) Int. Cl. H04N 7/26

(52) U.S. Cl. 375/240.03; 375/240.02; 375/E07.126

(57) ABSTRACT

An encoder of an embodiment includes: a hierarchical coding portion configured to hierarchically code an inputted video signal into video data of a base layer and one or more enhancement layers; a supplemental information generating portion configured to, on a basis of the video data of the base layer, generate supplemental information used for error concealment of the hierarchically coded video data of the base layer; and an arranging portion configured to arrange and output the video data from the hierarchical coding portion and the supplemental information.

### CROSS-REFERENCE TO RELATED APPLICATION

This application is based upon and claims the benefit of priority from the prior Japanese Patent Applications No. 2011-044370, filed on Mar. 1, 2011; the entire contents of which are incorporated herein by reference.

### FIELD

An embodiment herein relates generally to an encoder, a video transmission apparatus and an encoding method.

### BACKGROUND

Recently, digitalized image processing has become popular, and a coding technique such as H.264/AVC has been often adopted for transmission of digital video signals. Also, in recent years, H.264/AVC has been extended into H.264/SVC, which performs hierarchical scalable coding. It is conceived that SVC (Scalable Video Coding) will become an important technique in video distribution with diversification of transmission paths and audio-visual environments.

H.264/SVC has data structure composed of a base layer (lower hierarchy) and an enhancement layer (higher hierarchy), and the following three types of scalability are defined.
(1) Spatial scalability
(2) Temporal scalability
(3) SNR scalability

A decoder can decode data of a base layer to give minimum information required to play moving images. Also, a decoder decodes data of an enhancement layer as needed to allow for playing moving images with higher quality.

However, if data of a base layer is lost due to a transmission path error, a decoder cannot perform correct error concealment by using only data of an enhancement layer. Also, the decoder needs the read-in of the data of the enhancement layer as well as the base layer in order to reconstruct the lost data of the base layer from data of other pictures; accordingly, an amount of processing for reconstructing the base layer will be enormous.

Thus, it is conceived that base layers are more strongly error correction coded than enhancement layers to improve resistance to transmission path errors. As a result, however, the decoders need adaptation to different error correction processing between base layers and enhancement layers, and an SVC advantage is lost that even low-performance decoders can display some degree of images.

### BRIEF DESCRIPTION OF THE DRAWINGS

FIG. 1 is a block diagram illustrating a video transmission apparatus incorporating an encoder according to an embodiment of the present invention;

FIG. 2 is a diagram for explaining a relationship between video data of base layers and video data of enhancement layers;

FIGS. 3A to 3D are diagrams for explaining multiplexing processing performed by a multiplexer 12;

FIG. 4 is a diagram for explaining the embodiment;

FIG. 5 is a flow chart for explaining the embodiment; and

FIG. 6 is a diagram for illustrating an example of a format of video data outputted from the multiplexer 12.

### DETAILED DESCRIPTION

An encoder of an embodiment includes: a hierarchical coding portion configured to hierarchically code an inputted video signal into video data of a base layer and one or more enhancement layers; a supplemental information generating portion configured to, on a basis of the video data of the base layer, generate supplemental information used for error concealment of the hierarchically coded video data of the base layer; and an arranging portion configured to arrange and output the video data from the hierarchical coding portion and the supplemental information.

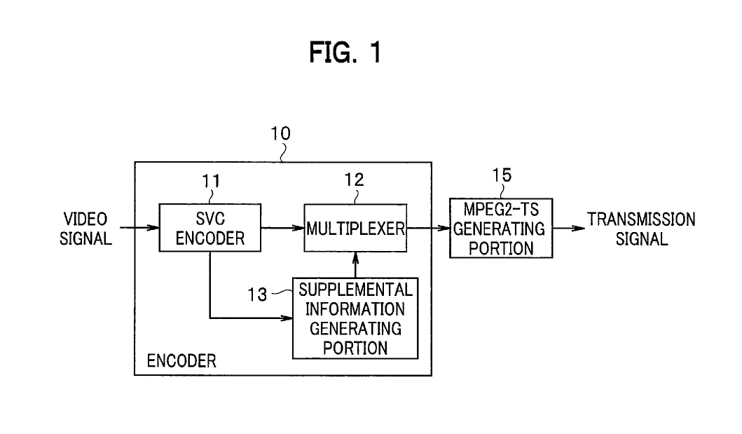

An embodiment of the present invention will now be described in detail with reference to the drawings. FIG. 1 is a block diagram illustrating a video transmission apparatus incorporating an encoder according to the embodiment of the present invention.

An SVC encoder 11 of an encoder 10 receives video signals (as input). The SVC encoder 11 generates video data of a base layer and one or more enhancement layers on the basis of the inputted video signals. The SVC encoder 11 adopts at least one of spatial, time, and SNR scalabilities to generate video data of the base layer and the enhancement layers.

The SVC encoder 11 can adopt the spatial scalability to output hierarchical video data of a plurality of resolutions. The SVC encoder 11 generates base video data of a low resolution in the base layer and generates video data of a high resolution in the enhancement layer. For example, the SVC encoder 11 generates video data of a QCIF (Quarter CIF) standard in the base layer and generates video data of a CIF (Common Intermediate Format) standard or a VGA (Video Graphics Array) standard in the enhancement layer.

Also, the SVC encoder 11 can adopt the temporal scalability to provide a plurality of types of hierarchical video data at different frame rates. The SVC encoder 11 generates base video data at a lowest frame rate in the base layer and generates video data at a higher frame rate in the enhancement layer. For example, the SVC encoder 11 generates video data at 7.5 fps (frame/rate) in the base layer and generates video data at 15 or 30 fps in the enhancement layer.

Furthermore, the SVC encoder 11 can adopt the SNR scalability to provide a plurality of types of hierarchical video data with different image qualities. The SVC encoder 11 generates base video data with a lowest image quality in the base layer and generates video data with a higher image quality in the enhancement layer. For example, the SVC encoder 11 generates video data including a DC component of DCT conversion factors in the base layer and generates video data including a higher frequency component of the DCT conversion factors in a higher enhancement layer.

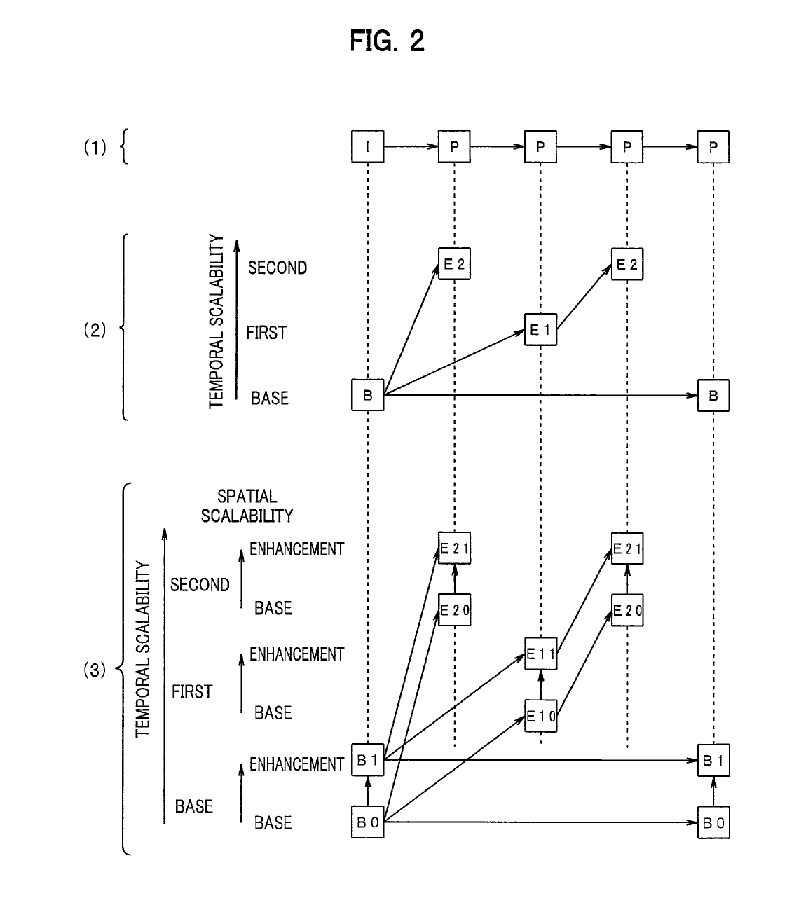

FIG. 2 is a diagram for explaining a relationship between video data of base layers and video data of enhancement layers. An example of (1) illustrates the case of no scalability, an example of (2) illustrates the case of the temporal scalability, and an example of (3) illustrates the case of the time and the spatial scalabilities. In FIG. 2, boxes indicate video data of frames in the base layers and the enhancement layers and arrows indicate correlations. Also, in FIG. 2, a time for each frame in a horizontal direction indicates a relationship between each frame and encoding.

The SVC encoder 11 generates video data of each enhancement layer by enhancing video data of a base layer. That is, as indicated by the arrows in FIG. 2, there is a correlation that higher hierarchical data depends on lower hierarchical data.

The example of (1) in FIG. 2 is the case of no scalability, and each frame is encoded without being layered. Reference character I in (1) denotes an intraframe coded picture (I picture) and reference character P denotes a one-way predictive coded P picture. Each picture has a correlation indicated by the arrows and if a transmitted I picture is not reconstructed, the subsequent P pictures cannot be correctly error-concealed at a decoding side.

In (2) of FIG. 2, a base layer and two-layered enhancement layers are shown in the temporal scalability. In (2), the base layer denoted by reference character B is composed of video data having a quarter of the frame rate in (1). Also, video data having a half of the frame rate in (1) is composed of the data of the base layer and data of the lower hierarchical enhancement layer denoted by reference character E1. Further, video data having the same frame rate as (1) can be obtained by using data of the higher hierarchical enhancement layer denoted by reference character E2, in addition to the foregoing data.

In (3) of FIG. 2, hierarchical coding that uses the time and the spatial scalabilities is shown. Reference character B1 denotes high-resolution video data (enhancement layer) with respect to low-resolution video data (base layer) denoted by reference character B0. Also, reference character E11 denotes high-resolution video data (enhancement layer) with respect to low-resolution video data (base layer) denoted by reference character E10, and reference character E21 denotes high-resolution video data (enhancement layer) with respect to low-resolution video data (base layer) denoted by reference character E20. Reference character B0 denotes the data of the base layer in the time and the spatial scalabilities, and if the data of reference character B0 is lost, correct error concealment cannot be performed at the decoding side even if the data of the enhancement layers is used.

The SVC encoder 11 outputs the generated data of the base layer and the data of each enhancement layer to the multiplexer 12. The multiplexer 12 also receives supplemental information generated by a supplemental information generating portion 13 described later. The multiplexer 12 multiplexes the output from the SVC encoder 11 and the supplemental information and outputs the resultant data.

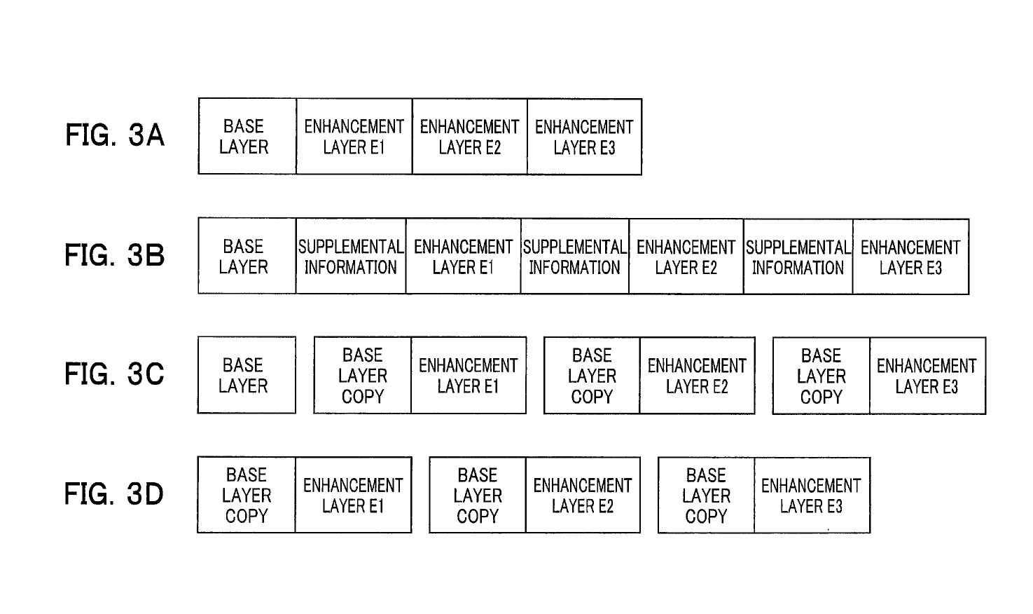

FIGS. 3A to 3D are diagrams for explaining the multiplexing processing performed by the multiplexer 12. If it is assumed that the multiplexer 12 multiplexes only the output from the SVC encoder 11 without using supplemental information, for example, the multiplexer 12 may arrange the data of the base layer and the data of the enhancement layer in the data arrangement as shown in FIG. 3A. Specifically, in this case, as shown in FIG. 3A, the data of the base layer, followed by each of the enhancement layers E1, E2, E3, and so on is arranged. In the example of FIG. 2, the data of reference character B0 and the data of reference characters B1, E10 to E21 are arranged as the data of the base layer and the data of the enhancement layers E1, E2, and so on, respectively.

As described above, if the data of the base layer is lost, error concealment cannot be correctly performed at the decoding side with only the data of the enhancement layers. Thus, in the present embodiment, in order to enable sufficient decoding even if the data of the base layer is lost at the decoding side, the supplemental information generating portion 13 generates supplemental information for supplementing decoding.

The supplemental information is added to each enhancement layer, and the resultant information and enhancement layers are arranged by the multiplexer 12. For example, as shown in FIG. 3B, the multiplexer 12 adds and arranges supplemental information immediately before each of enhancement layers El, E2 and so on. At a decoding side, sufficient decoding can be performed by using the supplemental information even if the data of the base layer is lost.

The supplemental information generating portion 13 generates, as supplemental information, information that allows sufficient decoding at the decoding side even if the data of the base layer is lost. For example, as the most reliable method of allowing for decoding with high quality at the decoding side, the supplemental information generating portion 13 may use entire data of a base layer as supplemental information.

FIG. 3C shows the output from the multiplexer 12 in this case. Data of a copy of the base layer is added to each of the enhancement layers E1, E2, and E3. Thus, even if the data of the base layer is lost at the decoding side, reliable decoding can be performed by using the data of the copies of the base layer.

FIG. 3D shows an example that the data of the base layer is omitted from the arrangement made by the multiplexer 12. Since the data of the copy of the base layer is added to each of the enhancement layers E1, E2, and E3, the transmission of the data of the base layer may be omitted.

However, because in a manner as shown in FIGS. 3C and 3D, the data of the base layer is needed to be transmitted a plurality of times, disadvantageously, an amount of coding increases. Thus, in the present embodiment, the supplemental information generating portion 13 generates, as supplemental information, information significant for decoding on the basis of the data of the base layer.

That is, in the present embodiment, as supplemental information, the supplemental information generating portion 13 adopts a parameter used for coding the base layer. For example, as supplemental information, the supplemental information generating portion 13 uses a motion vector, intramode/intermode information and quantization information generated from the data of the base layer. The supplemental information generating portion 13 generates at least one of a motion vector, intramode/intermode information and quantization information from the data of the base layer and sends the generated information to the multiplexer 12 as supplemental information. The multiplexer 12 adds the supplemental information to each enhancement layer. The output from the multiplexer 12 is sent to an MPEG2-TS generating portion 15. The MPEG2-TS generating portion 15 packetizes the inputted data using an MPEG standard and transmits the resultant data as a transmission signal.

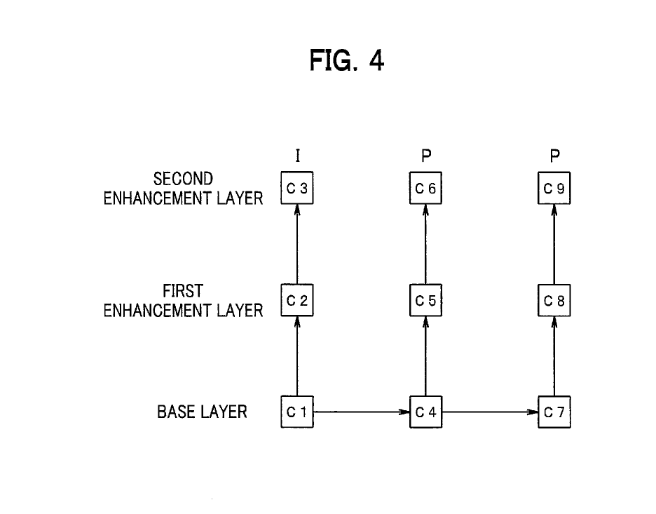

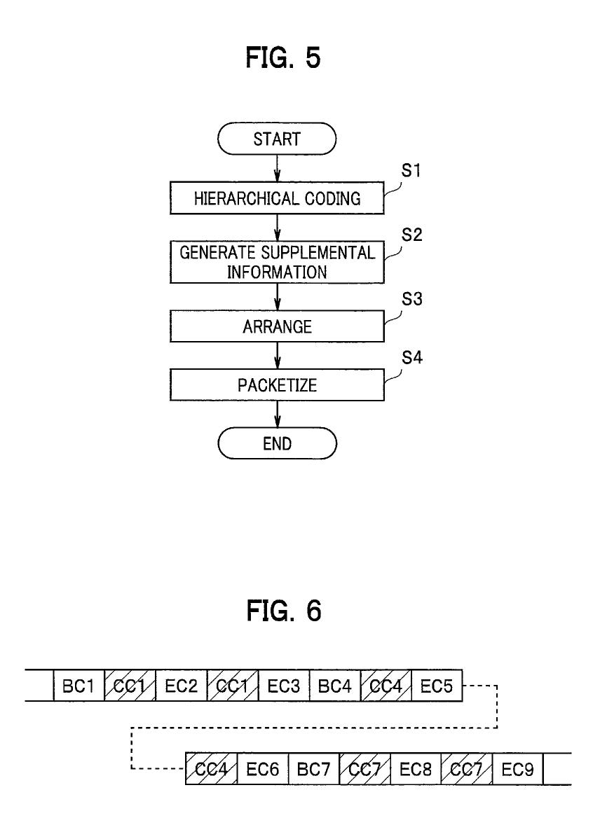

Next, an operation of the embodiment having such a configuration will be described with reference to FIGS. 4 to 6. FIG. 4 is a diagram for explaining the embodiment, and FIG. 5 is a flow chart for explaining the embodiment. Also, FIG. 6 is a diagram for illustrating an example of a format of video data outputted from the multiplexer 12.

A video signal is inputted to the SVC encoder 11 of the encoder 10. The SVC encoder 11 adopts at least one of the spatial, the time and the SNR scalabilities to hierarchically code the inputted video signal, thereby generating video data of the base layer and each enhancement layer (in step S1 of FIG. 5). The video data of the base layer and each enhancement layer is sent to the multiplexer 12 from the SVC encoder 11.

On the other hand, the supplemental information generating portion 13 generates at least one of a motion vector, intramode/intermode information and quantization information on the basis of the video data of the base layer and outputs the generated information to the multiplexer 12 (step S2). The multiplexer 12 adds supplemental information to the data of the base layer and the enhancement layer from the SVC encoder 11 and arranges them (step S3).

With reference to an example of FIG. 4, the data outputted from the multiplexer 12 will be described. FIG. 4 illustrates an example of hierarchical coding on three frames of images. In FIG. 4, an I picture, to be intraframe coded, is constituted of a base layer C1, a first enhancement layer C2, and a second enhancement layer C3; a P picture, a next picture, is constituted of a base layer C4, a first enhancement layer C5, and a second enhancement layer C6; and a P picture, another next picture, is constituted of a base layer C7, a first enhancement layer C8, and a second enhancement layer C9. The data of each layer has correlations as denoted by arrows in FIG. 4.

The video data from the SVC encoder 11 is outputted in ascending order of index numbers shown in FIG. 4. Specifically, if it is assumed that video data items of base layers C1, C4, and C7 are BC1, BC4, and BC7, respectively and video data items of enhancement layers C2, C3, C5, C6, C8, and C9 are EC2, EC3, EC5, EC6, EC8, and EC9, respectively, the SVC encoder 11 outputs the data items of BC1, EC2, EC3, BC4, EC5, EC6, BC7, EC8, and EC9 in this order.

The supplemental information generating portion 13 generates supplemental information CC1, CC4, and CC7 from the video data of the base layers C1, C4, and C7, respectively. The multiplexer 12 arranges the outputs from the SVC encoder 11 with the supplemental information added to the outputs, thereby outputting one item of video data shown in FIG. 6.

As illustrated in FIG. 6, in the outputs from the multiplexer 12, the supplemental information CC1 (shaded areas) is arranged before each of the data EC2 and the data EC3 of the enhancement layers, the supplemental information CC4 (shaded areas) is arranged before each of the data EC5 and the data EC6 of the enhancement layers, and the supplemental information CC7 (shaded areas) is arranged before each of the data EC8 and the data EC9 of the enhancement layers.

Therefore, at a decoding side, even if data of a base layer is lost, the data of the base layer and data of an enhancement layer can be relatively easily reconstructed by using supplemental information. Output of the multiplexer 12 is sent to the MPEG2-TS generating portion 15 and packetized in accordance with the MPEG standard, thereafter being transmitted as a transmission signal.

For example, assume that the data BC4 of the base layer C4 is lost at a decoding side due to a transmission path error or the like. In this case, the decoder uses the supplemental information CC4 to generate reconstructed data of the base layer C4. For example, the supplemental information CC4 is constituted of a motion vector, intramode/intermode information, quantization information, and the like that are adopted when the video data of the base layer C4 is encoded, and the video data of the base layer C4 can be efficiently reconstructed by using the supplemental information CC4.

For example, by using the motion vector employed when the base layer C4 is coded and the video data of the base layer C1, as compared with the case of not using the supplemental information CC4, the video data of the base layer C4 can be easily and accurately reconstructed. Thereby, at a decoder side, video display can be provided in a desired number of layers. For example, relatively low-quality video may be displayed using only the video data of the base layer C4 reconstructed by using the supplemental information CC4 and the video data of the base layers C1 and C7, or high-quality video may also be displayed using the video data of the first enhancement layer or a higher layer in addition to the foregoing base layer data.

In the description made with reference to FIGS. 3C and 3D, an amount of data is increased because copies of a base layer are transmitted as supplemental information. However, if the data arrangements in FIGS. 3C and 3D are adopted in the SNR scalability, an increased amount of data is little.

In the SNR scalability, a low frequency component to high frequency components of DCT conversion factors are assigned to a base layer and a plurality of enhancement layers. For example, it is conceived that only a DC component of DCT conversion factors is assigned to a base layer. That is, in this case, it is conceived that an amount of the base layer data is sufficiently lower than an amount of the enhancement layer data. Therefore, even if the supplemental information, which is a copy of the base layer, is added to each enhancement layer, an increased amount of data is little. Thus, the data arrangements in FIGS. 3C and 3D are advantageous in the SNR scalability.

On the other hand, in the time and spatial scalabilities, information of a base layer is information of a frame unit. Thus, instead of adding entire copies of the base layer as supplemental information, if a motion vector and intramode/intermode information are added to each enhancement layer as supplemental information, an increase in an amount of data can be more reduced.

As hereinbefore discussed, in the present embodiment, supplemental information obtained from video data of a base layer is added to each enhancement layer before transmission, so that a decoding side can use the supplemental information to reconstruct the data of the base layer with high precision. Thereby, even if the base layer is lost at the decoding side, the video is capable of being reconstructed using video data including the base layer and the enhancement layer, and image transmission with improved resistance to transmission path errors can be provided. Further, by using a motion vector, intramode/intermode information and quantization information as supplemental information, even if the supplemental information is added to an enhancement layer before transmission, an amount of data can be prevented from substantially increasing.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. An encoder comprising:
a hierarchical coding portion configured to hierarchically code an inputted video signal into video data of a base layer and one or more enhancement layers;
a supplemental information generating portion configured to, on a basis of the video data of the base layer, generate supplemental information used for error concealment of the hierarchically coded video data of the base layer; and
an arranging portion configured to arrange and output the video data from the hierarchical coding portion and the supplemental information.

2. The encoder according to claim 1, wherein
the arranging portion arranges the video data of the base layer, followed by a same number of sets of the supplemental information and the video data of the enhancement layers as a number of the enhancement layers.

3. The encoder according to claim 1, wherein
the arranging portion arranges a same number of sets of the supplemental information and the video data of the enhancement layers as a number of the enhancement layers.

4. The encoder according to claim 1, wherein
the supplemental information is video data of the base layer.

5. The encoder according to claim 2, wherein
the supplemental information is video data of the base layer.

6. The encoder according to claim 3, wherein
the supplemental information is video data of the base layer.

7. The encoder according to claim 5, wherein
the hierarchical coding portion adopts an SNR scalability to hierarchically code the inputted video signal.

8. The encoder according to claim 6, wherein
the hierarchical coding portion adopts an SNR scalability to hierarchically code the inputted video signal.

9. The encoder according to claim 1, wherein
the supplemental information is a parameter used to code the video data of the base layer.

10. The encoder according to claim 1, wherein
the supplemental information is at least one of a motion vector, intramode/intermode information and quantization information.

11. The encoder according to claim 1, wherein
the hierarchical coding portion adopts at least one of a spatial scalability, a temporal scalability and an SNR scalability to hierarchically code the inputted video signal.

12. The encoder according to claim 2, wherein
the hierarchical coding portion adopts at least one of a spatial scalability and a temporal scalability to hierarchically code the inputted video signal.

13. The encoder according to claim 3, wherein
the hierarchical coding portion adopts at least one of a spatial scalability and a temporal scalability to hierarchically code the inputted video signal.

14. A video transmission apparatus comprising:
an encoder including a hierarchical coding portion configured to hierarchically code an inputted video signal into video data of a base layer and one or more enhancement layers; a supplemental information generating portion configured to, on a basis of the video data of the base layer, generate supplemental information used for error concealment of the hierarchically coded video data of the base layer;
and an arranging portion configured to arrange and output the video data from the hierarchical coding portion and the supplemental information; and
a format converting portion configured to convert output of the arranging portion into a transmission format and transmit the resultant output.

15. The video transmission apparatus according to claim 14, wherein
the supplemental information is the video data of the base layer.

16. The video transmission apparatus according to claim 14, wherein
the supplemental information is a parameter used to code the video data of the base layer.

17. The video transmission apparatus according to claim 14, wherein
the supplemental information is at least one of a motion vector, intramode/intermode information and quantization information.

18. An encoding method comprising:
hierarchically coding a video signal inputted at an input portion into video data of a base layer and one or more enhancement layers;
generating, on a basis of the video data of the base layer, supplemental information used for error concealment of the hierarchically coded video data of the base layer; and
arranging and outputting the video data from the hierarchical coding portion and the supplemental information.

19. The encoding method according to claim 18, wherein
the supplemental information is the video data of the base layer.

20. The encoding method according to claim 18, wherein
the supplemental information is a parameter used to code the video data of the base layer.
